(19) United States
(12) Patent Application Publication
(10) Pub. No.: US 2026/0100829 A1
(43) Pub. Date: Apr. 9, 2026

(54) ELECTRONIC DEVICE AND CONTROL METHOD THEREOF

(71) Applicant: SAMSUNG ELECTRONICS CO., LTD., Suwon-si (KR)

(72) Inventors: Seungyong JOO, Suwon-si (KR); Seona PARK, Suwon-si (KR); Hyunjun AN, Suwon-si (KR)

(73) Assignee: SAMSUNG ELECTRONICS CO., LTD., Suwon-si (KR)

(21) Appl. No.: 19/317,920

(22) Filed: Sep. 3, 2025

Related U.S. Application Data
(63) Continuation of application No. PCT/KR2025/011930, filed on Aug. 7, 2025.

(30) Foreign Application Priority Data
Oct. 4, 2024 (KR) 10-2024-0135056

(51) Int. Cl. H04L 9/08

(52) U.S. Cl. CPC H04L 9/088

(57) ABSTRACT

A method of an electronic device communicated with a server device, includes: receiving playback schedule information that includes a plurality of pieces of content, a disclosure restriction status, and validity period information, wherein the disclosure restriction status and the validity period information correspond to each of the plurality of pieces of content; identifying disclosure restriction content to which encryption is applied among the plurality of pieces of content; transmitting a decryption request for the disclosure restriction content to the server device when a time before a predetermined time is reached based on a playback start time of the disclosure restriction content; when an encryption key corresponding to the disclosure restriction content is received from the server device, decrypting the disclosure restriction content using the encryption key; and displaying, on the display, the plurality of pieces of content including the decrypted disclosure restriction content based on the validity period information.

### CROSS-REFERENCE TO RELATED APPLICATIONS

This application is a by-pass continuation application of International Application No. PCT/KR2025/011930, filed on August 7, 2025, which is based on and claims priority to Korean Patent Application No. 10-2024-0135056, filed on October 4, 2024, in the Korean Intellectual Property Office, the disclosures of which are incorporated by reference herein in their entireties.

### BACKGROUND

### 1. Field

Apparatuses and methods relate to an electronic device (e.g., a digital signage) and a control method of the electronic device.

### 2. Description of Related Art

As a digital signage (e.g., to provide advertising content) has increasingly been used, technologies for the digital signage have been developed.

The digital signage is configured to provide advertising content through large displays in large buildings, shopping malls, public places, etc. The digital signage is configured to provide advertising content only at certain times to minimize exposure according to the characteristics of the advertising content.

Generally, in a case of the advertising content, a manager (who manages the digital signage) need to upload the advertising content into the digital signage and schedule a playback time of the advertising content, thus the advertising content is played at the scheduled playback time by the digital signage.

### SUMMARY

According to an aspect of the disclosure, an electronic device communicated with a server device, includes: communication circuitry; a display; a memory configured to store instructions; and one or more processors configured to include a processing circuitry, wherein, when the instructions are individually or collectively executed, the one or more processors cause the electronic device to: receive, through the communication circuitry, playback schedule information that includes a plurality of pieces of content, a disclosure restriction status, and validity period information, wherein the disclosure restriction status and the validity period information correspond to each of the plurality of pieces of content, identify, among the plurality of pieces of content, disclosure restriction content to which an encryption is applied, when a predetermined time, which is prior to a disclosure start time of the disclosure restriction content, is reached, transmit a decryption request for the disclosure restriction content to the server device through the communication circuitry, when an encryption key corresponding to the disclosure restriction content is received from the server device, decrypt the disclosure restriction content using the encryption key, and display, on the display, the plurality of pieces of content including the decrypted disclosure restriction content based on the validity period information.

According to an aspect of the disclosure, a server device communicated with an electronic device, the server device includes: communication circuitry; a memory configured to store instructions; and one or more processors configured to include a processing circuitry, wherein, when the instructions are individually or collectively executed, the one or more processors cause the server device to: when a plurality of pieces of content, disclosure restriction status, and validity period information are received, identify, among the plurality of pieces of content, disclosure restriction content with a disclosure restriction set, wherein the disclosure restriction status and the validity period information correspond to each of the plurality of pieces of content, encrypt the disclosure restriction content using an encryption key, acquire playback schedule information of the plurality of pieces of content including the encrypted disclosure restriction content, transmit the playback schedule information to the electronic device through the communication circuitry, and when a request for decryption of the disclosure restriction content is received from the electronic device, transmit the encryption key corresponding to the disclosure restriction content to the electronic device through the communication circuitry.

According to an aspect of the disclosure, a method of an electronic device communicated with a server device, includes: receiving playback schedule information that includes a plurality of pieces of content, a disclosure restriction status, and validity period information, wherein the disclosure restriction status and the validity period information correspond to each of the plurality of pieces of content; identifying disclosure restriction content to which encryption is applied among the plurality of pieces of content; transmitting a decryption request for the disclosure restriction content to the server device when a time before a predetermined time is reached based on a playback start time of the disclosure restriction content; when an encryption key corresponding to the disclosure restriction content is received from the server device, decrypting the disclosure restriction content using the encryption key; and displaying, on the display, the plurality of pieces of content including the decrypted disclosure restriction content based on the validity period information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an operation of an electronic device according to one or more embodiments;

FIG. 2 illustrates a configuration of the electronic device according to one or more embodiments;

FIG. 3 illustrates a process of identifying disclosure restriction content of the electronic device according to one or more embodiments;

FIG. 4 illustrates a process of decrypting the disclosure restriction content of the electronic device according to one or more embodiments;

FIG. 5 illustrates a process of deleting content of the electronic device according to one or more embodiments;

FIG. 6 is a flowchart for describing an overall operation of an electronic device according to one or more embodiments;

FIG. 7 illustrates a configuration of a server device according to one or more embodiments;

FIG. 8 illustrates a process of acquiring playback schedule information of a server device according to one or more embodiments;

FIG. 9 illustrates a process of converting valid period information of the server device according to one or more embodiments; and

FIG. 10 is a flowchart for describing an overall operation of a server device according to one or more embodiments.

### DETAILED DESCRIPTION

General terms that are currently widely used were selected as terms used in one or more embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present disclosure. Therefore, the terms used in the present disclosure are defined on the basis of the meaning of the terms and the contents throughout the present disclosure rather than simple names of the terms.

In the present disclosure, an expression “have,” “may have,” “include,” “may include,” or the like, indicates existence of a corresponding feature (for example, a numerical value, a function, an operation, a component such as a part, or the like), and does not exclude existence of an additional feature.

An expression “at least one of A and/or B” is to be understood to represent “A” or “B” or “any one of A and B.”

Expressions “first,” “second,” “1st” or “2nd” or the like, used in the present disclosure may indicate various components regardless of a sequence and/or importance of the components, will be used only in order to distinguish one component from the other components, and do not limit the corresponding components.

When it is mentioned that any component (for example, a first component) is (operatively or communicatively) coupled with/to or is connected to another component (for example, a second component), any component is directly coupled to another component or may be coupled to another component through the other component (for example, a third component).

Singular expressions are intended to include plural expressions unless the context clearly indicates otherwise. Terms “include” or “configure” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

A “module” or a “~er/or” may perform at least one function or operation, and be implemented by hardware or software or be implemented by a combination of hardware and software. In addition, a plurality of “modules” or a plurality of “~ers/~ors” may be integrated in at least one module and be implemented by at least one processor (not illustrated) except for a “module” or a “~er/or” that needs to be implemented by specific hardware.

A “user” may refer to a person using an electronic device or a device used by the person.

Hereinafter, an embodiment of the disclosure will be described in detail with reference to the accompanying drawings.

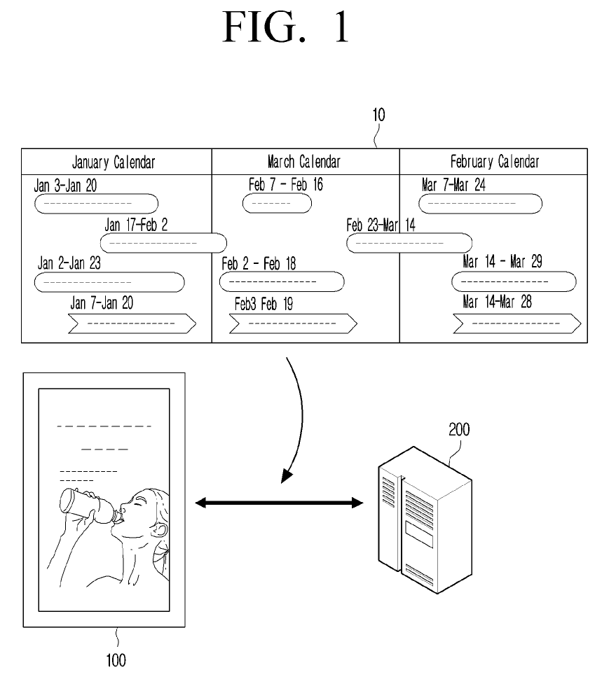

FIG. 1 illustrates an operation of an electronic device according to one or more embodiments.

According to an embodiment, an electronic device 100 may display content received from a server device 200 through a display. Here, the electronic device 100 may be implemented as various types of electronic devices such as a digital signage, a smart TV, a monitor, a kiosk, a tablet PC, an electronic picture frame, a mobile phone, a large format display (LFD), a digital information display (DID), a video wall, and a projector display. However, in some cases, the electronic device 100 may be an image processing device (e.g., a set-top box, one connected box) that is connected to the electronic device and provides an image.

According to an embodiment, the electronic device 100 may receive a playback schedule 10 for content from the server device 200. The electronic device 100 may display or disclose the content through the display based on the playback schedule 10 for the content.

The playback schedule 10 may be a content schedule (or program schedule) for a plurality of pieces of content. The playback schedule 10 may include information corresponding to a disclosure start time and a disclosure end time for the plurality of pieces of content or one content. The playback schedule 10 may be a schedule configured in the form of a timeline of a disclosure schedule for the plurality of pieces of content to be displayed on the display.

The disclosure of the content may include an operation of visually displaying the content to an unspecified person or a specific person by playing the content through the display. For example, the disclosure of the content may include an operation of visually disclosing advertising content for a specific product to an unspecified person or a specific person at a specific time.

The server device 200 may be configured to receive schedule information corresponding to a plurality of pieces of content and a plurality of pieces of advertising content, respectively, from a plurality of advertising business servers, and acquiring a playback schedule 10 for the content. Here, the server device 200 may be a PC, a laptop PC, a mobile phone, a tablet PC, or a cloud server.

Referring to FIG. 1, the electronic device 100 may receive the plurality of pieces of content and the playback schedule 10 for the plurality of pieces of content from the server device 200. The playback schedule 10 may include information about a content title, a disclosure start time, and a disclosure end time. The electronic device 100 may identify the disclosure start time of the advertising content 20 from the playback schedule 10 and display the advertising content 20 at the corresponding time through the display.

However, the electronic device 100 may display the advertising content 20 through the display even though it is not the disclosure start time of the advertising content 20. In this case, the electronic device 100 may receive encrypted content from the server device 200, decrypt the content, and display the content at the disclosure start time.

Hereinafter, one or more embodiments of the electronic device 100 receiving encrypted content and decrypting the encrypted content will be described with reference to the drawings.

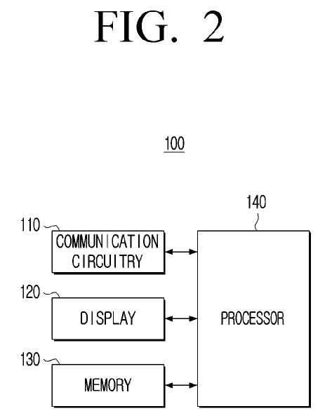

FIG. 2 illustrates a configuration of the electronic device according to one or more embodiments.

Referring to FIG. 2, the electronic device 100 includes communication circuitry 110, a display 120, a memory 130, and one or more processors 140. However, the present disclosure is not limited thereto, and the electronic device 100 may be implemented in a form in which some components are excluded, or may be implemented in a form in which other components are further included.

The communication circuitry 110 may include wired or wireless input/output interfaces (or input/output terminals) according to various standards. The communication circuitry 110 may be a component performing communication with various types of external apparatuses depending on various types of communication manners. The communication circuitry 110 may include a wireless communication module or a wired communication module. Here, each communication module may be implemented in the form of at least one hardware chip.

The communication circuitry 110 may include various interfaces such as a high definition multimedia interface (HDMI), a mobile high-definition link (MHL), universal serial bus (USB), a display port (DP), thunderbolt, a video graphics array (VGA) port, an RGB port, a D-subminiature (D-SUB), a digital visual interface (DVI), Bluetooth®, Zigbee, wired/wireless local area network (LAN), a wide area network (WAN), Ethernet, IEEE 1394, Audio Engineering Society/European Broadcasting Union (AES/EBU), optical, and coaxial.

The display 120 is a component for displaying the plurality of pieces of content received from the server device. The display 120 may be implemented as a display including a self-light emitting element or a display including a non-light emitting element and a backlight. For example, the display 120 may be implemented as various types of displays such as a liquid crystal display (LCD), an organic light emitting diodes (OLED) display, light emitting diodes (LED), a micro LED, a Mini LED, a plasma display panel (PD), a quantum dot (QD) display, and quantum dot light-emitting diodes (QLED). A driving circuit, a backlight unit, and the like, that may be implemented in a form such as amorphous silicon (a-si) TFT, low temperature poly silicon (LTPS) TFT, an organic TFT (OTFT), and the like, may be included in the display 120.

The memory 130 may store at least one instruction, data, program, etc., necessary for the operation of the electronic device 100. For example, the memory 130 may store outline highlight processing information and location information corresponding to the selected image.

The memory 130 may be implemented in the form of a memory embedded in the electronic device 100 or a memory detachable from the electronic device 100 depending on the purpose of data storage. For example, data for driving the electronic device 100 may be stored in the memory embedded in the electronic device 100, and data for an extension function of the electronic device 100 may be stored in the memory attachable to and detachable from the electronic device 100.

The memory embedded in the robot 100 may be implemented in at least one of, for example, a volatile memory (for example, a dynamic random access memory (DRAM), a static RAM (SRAM), a synchronous dynamic RAM (SDRAM), or the like), a non-volatile memory (for example, a one-time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash, or the like), a hard drive, and a solid state drive (SSD)).

The memory 130 may be implemented as a single memory that stores data generated in various operations according to the present disclosure, but is not limited thereto, and the memory 130 may be implemented to include a plurality of memories that each store different types of data or each store data generated in different stages.

One or more processors 140 may be implemented to generally control the operation of the electronic device 100. Specifically, one or more processors 140 are connected to each component of the electronic device 100 and may control the overall operation of the electronic device 100. For example, one or more processors 140 are electrically connected to the communication circuitry 110, the display 120, and the memory 130 and may control the overall operation of the electronic device 100. One or more processors 140 may include a processing circuitry and may be composed of one or more processors.

One or more processors 140 may perform the operation of the electronic device 100 according to one or more embodiments by executing one or more instructions stored in the memory 130.

One or more processors 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. One or more processors 140 may control one or any combination of other components of the electronic device and may perform operations related to communication or data processing. One or more processors 140 may execute one or more programs or instructions stored in a memory. For example, one or more processors may perform a method according to one or more embodiments of the present disclosure by executing one or more instructions stored in the memory.

According to one or more embodiments of the present disclosure, when the method includes multiple operations, the multiple operations may be performed by one processor or by multiple processors. For example, when a first operation, a second operation, and a third operation are performed by the method according to one or more embodiments, the first operation, the second operation, and the third operation may all be performed by the first processor, or the first operation and the second operation may be performed by the first processor (e.g., a general-purpose processor) and the third operation may be performed by the second processor (e.g., an artificial intelligence (AI)-dedicated processor).

The one or more processors 140 may be implemented as a single core processor including one core, or may be implemented as one or more multi-core processors including multiple cores (e.g., a homogeneous multi-core or a heterogeneous multi-core). When one or more processors 140 are implemented as a multi-core processor, each of the plurality of cores included in the multi-core processor may include an internal processor memory such as cache memory and on-chip memory, and a common cache shared by the plurality of cores may be included in the multi-core processor. In addition, each of the plurality of cores (or some of the plurality of cores) included in the multi-core processor may independently read and execute a program command for implementing the method according to one or more embodiments of the present disclosure, or all (or some) of the plurality of cores may be linked to read and execute the program command for implementing the method according to one or more embodiments of the present disclosure.

According to one or more embodiments of the present disclosure, when the method includes a plurality of operations, the plurality of operations may be performed by one of the plurality of cores included in the multi-core processor, or may be performed by the plurality of cores. For example, when the first operation, the second operation, and the third operation are performed by the method according to one or more embodiments, the first operation, the second operation, and the third operation may all be performed by a first core included in the multi-core processor, or the first operation and the second operation may be performed by the first core included in the multi-core processor, and the third operation may be performed by a second core included in the multi-core processor.

In some embodiments of the present disclosure, a processor may mean a system on chip (SoC) in which one or more processors and other electronic components are integrated, a single core processor, a multi-core processor, or a core included in the single core processor or the multi-core processor. Here, the core may be implemented as the CPU, the GPU, the APU, the MIC, the DSP, the NPU, the hardware accelerator, the machine learning accelerator, etc., but the embodiments of the present disclosure are not limited thereto. Hereinafter, for convenience of description, one or more processors 140 will be referred to as the processor 140.

According to an embodiment, the processor 140 may receive, through the communication circuitry 110, playback schedule information that includes a plurality of pieces of content, and a disclosure restriction status and validity period information corresponding to each of the plurality of pieces of content.

According to one example, the disclosure restriction status may be information on whether the playback of the content is possible before the validity period corresponding to the content is reached. For example, in a case of the content to which the disclosure restriction is applied, the playback of the content may not be possible before the playback start time of the content is reached. However, in another case of the content to which the disclosure restriction is not applied, the playback of the content may be possible before the playback start time of the content is reached, but displaying the content through the display 120 may not be possible.

In one example, the validity period information may include at least one of the disclosure start time and the disclosure end time corresponding to each of the plurality of pieces of content. For example, the validity period information may include information about the disclosure start time of the content, 9:00 AM on October 10, and the disclosure end time, 9:00 AM on October 13.

In one example, the validity period information may include only the disclosure start time. In this case, the content may start to be disclosed after a specific time and may not end in disclosure. On the other hand, the validity period information may include only the disclosure end time. In this case, the content may start to be disclosed from the time the content is received from the server device 200, not at a specific time.

The playback schedule information may include information about the disclosure schedule of each of the plurality of pieces of content, as illustrated in FIG. 1. The playback schedule information may include information corresponding to the disclosure start time, the disclosure end time, and the disclosure restriction status of the content. The playback schedule information is not limited thereto and may be referred to as content timeline information or content arrangement information, but in this disclosure, it is collectively referred to as playback schedule information.

According to an embodiment, the processor 140 may identify the disclosure restriction content to which encryption is applied among the plurality of pieces of content.

The disclosure restriction content may be content set based on a user input for restricting disclosure before the preset start of disclosure among the plurality of pieces of content. In other words, the disclosure restriction content may be content to which the disclosure restriction is applied before the start of the disclosure of the content.

According to an embodiment, the processor 140 may transmit a decryption request for the disclosure restriction content to the server device 200 through the communication circuitry 110 when a time before a predetermined time is reached based on the playback start time of the disclosure restriction content.

The predetermined time may be determined based on at least one of the capacity of the disclosure restriction content and the network environment. For example, when the capacity of the content is large, the predetermined time may be larger than when the capacity of the content is small.

According to an embodiment, when the processor 140 receives an encryption key corresponding to the disclosure restriction content from the server device 200, the processor 140 may decrypt the disclosure restriction content based on the encryption key.

According to an embodiment, the processor 140 may display, on the display 120, the plurality of pieces of content including the decrypted disclosure restriction content based on the validity period information.

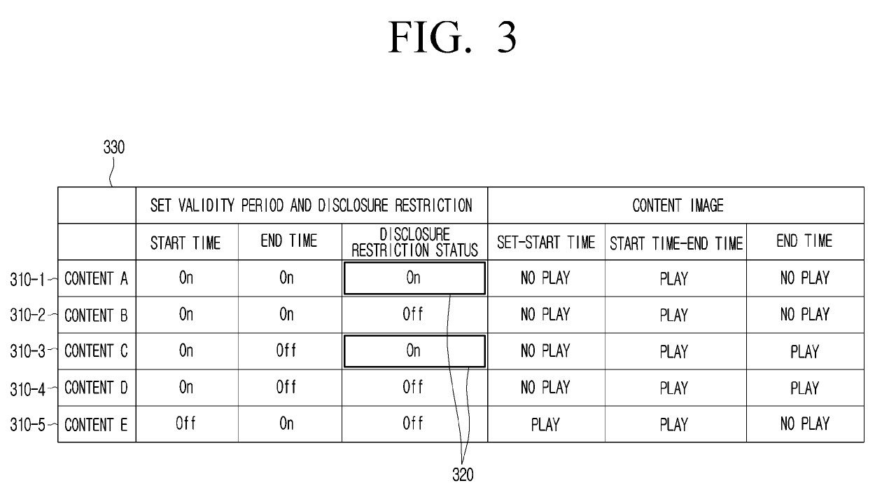

FIG. 3 illustrates a process of identifying disclosure restriction content of the electronic device according to one or more embodiments.

According to an embodiment, the electronic device 100 may identify the disclosure restriction content based on the plurality of pieces of content and the playback schedule information. The electronic device 100 may identify the disclosure restriction content among the plurality of pieces of content based on the disclosure restriction status set for each of the plurality of pieces of content.

According to an example, the electronic device 100 may receive the plurality of pieces of content to which the disclosure restriction status is applied from the server device 200. For example, in the case of content with disclosure restriction activated, information corresponding to ‘disclosure restriction On’ may be included in metadata of the content. For example, in the case of content with disclosure restriction activated, information corresponding to ‘disclosure restriction Off’ may be included in the metadata of the content.

Referring to FIG. 3, the electronic device 100 may receive playback schedule information 330 including disclosure restriction status and validity period information that correspond to each of a plurality of pieces of content 310-1 to 310-5 from the server device 200. The electronic device 100 may identify the disclosure restriction content based on the disclosure restriction status corresponding to each of the plurality of pieces of content 310-1 to 310-5.

The electronic device 100 may identify that the disclosure restriction status is ‘On’ based on metadata corresponding to content A 310-1 and content C 310-3. The electronic device 100 may identify the content A 310-1 and the content C 310-3 as the disclosure restriction content to which the encryption is applied.

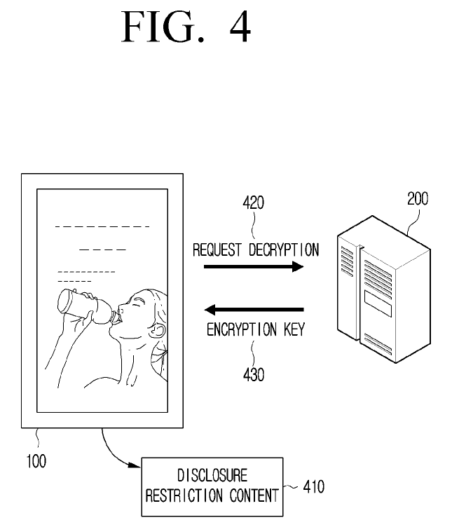

FIG. 4 illustrates a process of decrypting the disclosure restriction content of the electronic device according to one or more embodiments.

According to an embodiment, the electronic device 100 may transmit a decryption request 420 for disclosure restriction content 410 to the server device 200 when a time before a predetermined time is reached based on the disclosure start time of the disclosure restriction content 410.

For example, when the disclosure start time of the disclosure restriction content 410 is 9:00 AM on October 1, the electronic device 100 may transmit the decryption request 420 for the disclosure restriction content 410 to the server device 200 at 8:00 AM on October 1, which is one hour before 9:00 AM on October 1.

According to an embodiment, when the electronic device 100 receives an encryption key 430 corresponding to the disclosure restriction content 410 from the server device 200, the electronic device 100 may decrypt the disclosure restriction content 410 based on the received encryption key 430.

According to one example, the electronic device 100 may identify an encryption algorithm based on metadata of the encrypted disclosure restriction content 410. The electronic device 100 may decrypt the encrypted disclosure restriction content 410 by inputting the encryption key 430 to the identified algorithm.

Referring to FIG. 4, the electronic device 100 may transmit the decryption request 420 for the disclosure restriction content 410 to the server device 200. The server device 200 may identify the disclosure restriction content 410 for which the decryption request 420 has been received, and transmit the encryption key 430 corresponding to the disclosure restriction content 410 to the electronic device 100. The electronic device 100 may decrypt the disclosure restriction content 410 based on the encryption key 430 received from the server device 200.

According to an embodiment, the electronic device 100 may display the decrypted disclosure restriction content through the display 120 based on the validity period information.

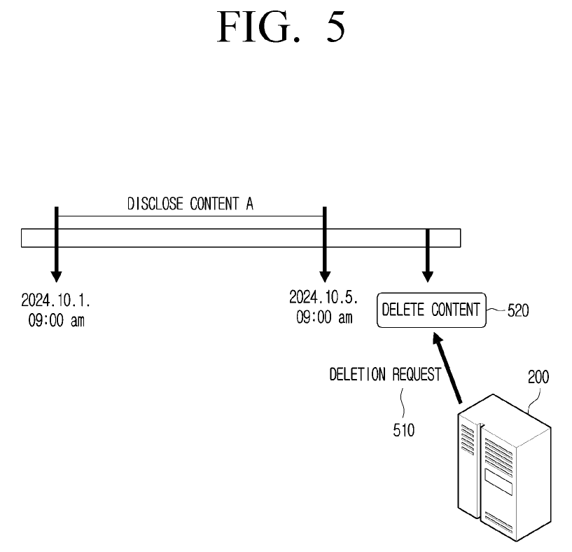

FIG. 5 illustrates a process of deleting content of the electronic device according to one or more embodiments.

According to an embodiment, the electronic device 100 may store, in the memory 130, the content schedule information (the playback schedule information) that includes the plurality of pieces of content, and the disclosure restriction status and the validity period information corresponding to each of the plurality of pieces of content received through the communication circuitry 110.

According to an embodiment, when a deletion request (operation 510) for the disclosure restriction content is received from the server device 200 after the validity period of the disclosure restriction content ends, the electronic device 100 may delete the disclosure restriction content from the memory 130.

Referring to FIG. 5, the electronic device 100 may identify the disclosure start time (9:00 AM on October 1, 2024) and the disclosure end time (9:00 AM on October 5, 2024) of the content A 310-1. The electronic device 100 may receive a deletion request for the content A 310-1 from the server device 200 after the disclosure termination time has elapsed. The electronic device 100 may delete (operation 520) the content A 310-1 from the memory 130 based on the content deletion request received from the server device 200.

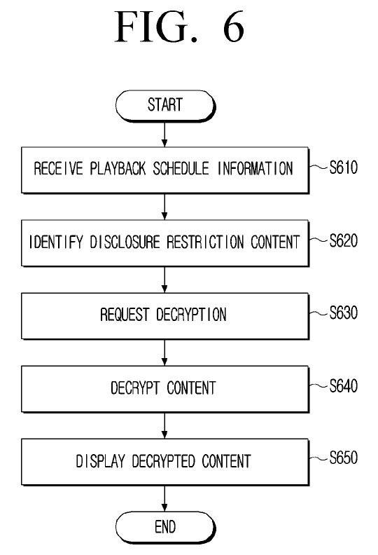

FIG. 6 is a flowchart for describing an overall operation of an electronic device according to one or more embodiments.

Referring to FIG. 6, in operation S610, the electronic device 100 may receive the playback schedule information that includes the plurality of pieces of content, and the disclosure restriction status and the validity period information corresponding to each of the plurality of pieces of content.

In operation S620, the electronic device 100 may identify the disclosure restriction content to which the encryption is applied among the plurality of pieces of content.

In operation S630, the electronic device 100 may transmit the decryption request for the disclosure restriction content to the server device 200 when the time before the predetermined time is reached based on the playback start time of the disclosure restriction content.

In operation S640, when the electronic device 100 receives the encryption key corresponding to the disclosure restriction content from the server device 200, the electronic device 100 may decrypt the disclosure restriction content based on the encryption key.

In operation S650, the electronic device 100 may display the plurality of pieces of content including the decrypted disclosure restriction content based on the validity period information.

Since the method of identifying disclosure restriction content and transmitting a decryption request for disclosure restriction content to a server device has been specifically described through the above-described embodiments, a description thereof will be omitted.

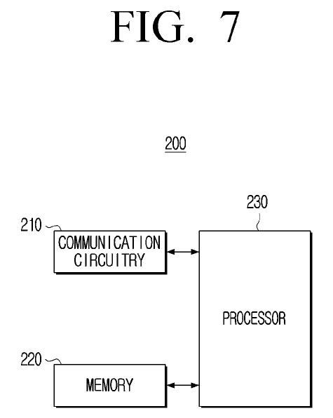

FIG. 7 illustrates a configuration of a server device according to one or more embodiments.

Referring to FIG. 7, the server device 200 includes communication circuitry 210, memory 220, and one or more processors 230. However, the present disclosure is not limited thereto, and the server device 200 may be implemented in a form in which some components are excluded, or may be implemented in a form in which other components are further included.

A detailed description for components overlapped with components illustrated in FIG. 2 among components illustrated in FIG. 7 will be omitted. Hereinafter, for convenience of description, one or more processors 230 will be referred to as the processor 230.

According to an embodiment, when the plurality of pieces of content, and the disclosure restriction status and the validity period information corresponding to each of the plurality of pieces of content are received, the processor 230 may identify the disclosure restriction content with the disclosure restriction set among the plurality of pieces of content.

The validity period information may be information including at least one of the disclosure start time and the disclosure end time corresponding to each of the plurality of pieces of content. The disclosure restriction status may include information on whether the content may be played before the validity period corresponding to the content is reached.

According to an embodiment, the processor 230 may encrypt the disclosure restriction content using the encryption key.

According to an embodiment, the processor 230 may acquire the playback schedule information of the plurality of pieces of content including the encrypted disclosure restriction content.

According to an embodiment, the processor 230 may transmit the playback schedule information to the electronic device 100 through the communication circuitry 210.

According to an embodiment, when a request for decryption of the disclosure restriction content is received from the electronic device 100, the processor 230 may transmit the encryption key corresponding to the disclosure restriction content to the electronic device 100 through the communication circuitry 210.

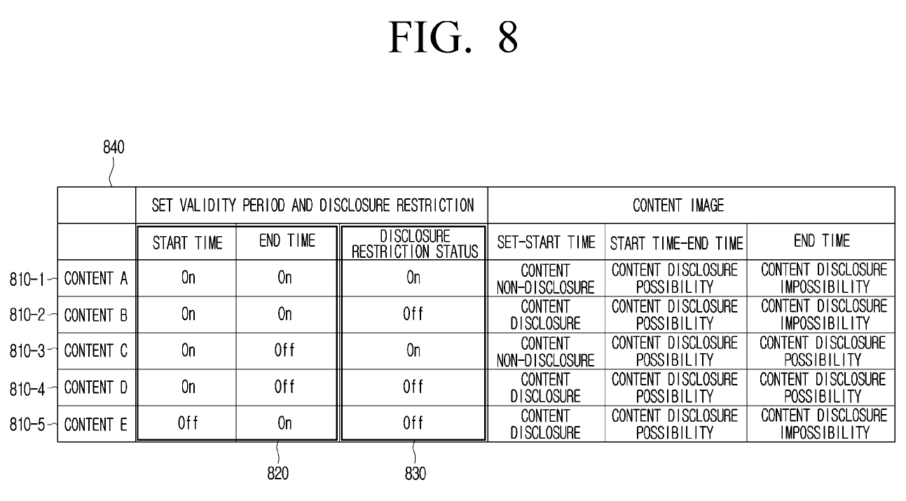

FIG. 8 illustrates a process of acquiring playback schedule information of a server device according to one or more embodiments.

According to an embodiment, the server device 200 may receive the plurality of pieces of content, and the disclosure restriction status and the validity period information corresponding to each of the plurality of pieces of content from the plurality of external servers.

According to an embodiment, the server device 200 may receive information corresponding to the disclosure start time and the disclosure end time corresponding to each of the plurality of pieces of content. For example, the server device 200 may receive a disclosure start time (9:00 AM on October 1, 2024) and a disclosure end time (9:00 AM on October 5, 2024) of the advertising content from the advertising business server.

According to an embodiment, the server device 200 may receive the disclosure restriction status based on the disclosure restriction information corresponding to each of the plurality of pieces of content. The disclosure restriction information may include information on whether the disclosure restriction is activated before the disclosure start time of the content.

Referring to FIG. 8, the server device 200 may receive a plurality of pieces of content 810-1 to 810-5, and validity period information 820 and disclosure restriction status 830 corresponding to each of a plurality of pieces of content 810-1 to 810-5 from at least one external server. The server device 200 may acquire playback schedule information 840 based on the validity period information 820 and the disclosure restriction status 830 received from at least one external server.

According to an embodiment, the server device 200 may identify the disclosure restriction content based on the disclosure restriction information for activating the disclosure restriction among the plurality of pieces of content. The server device 200 may identify the disclosure restriction content based on the disclosure restriction status of each of the plurality of pieces of content.

According to an embodiment, the server device 200 may encrypt the disclosure restriction content using an encryption key including a random string based on an encryption algorithm or a preset algorithm. The server device 200 may identify the encryption key corresponding to the disclosure restriction content and store the identified encryption key in the memory 220.

According to an embodiment, when the disclosure end time of the content is reached, the server device 200 may delete the content at the disclosure end time of the content. For example, when the disclosure end time of the content is set, the server device 200 may delete the content at the disclosure end time of the content.

According to an embodiment, the server device 200 may receive information about a user with control authority for each content. The server device 200 may identify a user with control authority and receive information corresponding to content modification and deletion from the user with control authority.

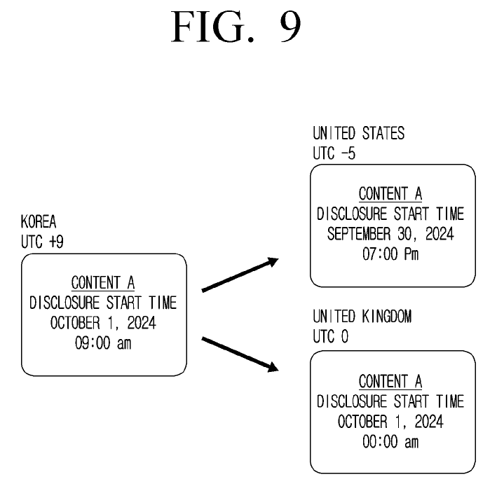

FIG. 9 illustrates a process of acquiring valid period information of the server device according to one or more embodiments.

According to an embodiment, the server device 200 may convert the validity period information corresponding to the plurality of pieces of content into coordinated universal time (UTC) information of a country where the electronic device 100 is located, and transmit the playback schedule information including the converted validity period information to the electronic device 100.

The UTC information is a standard time system used worldwide and may be time information that serves as a reference for all time zones. For example, the time in Korea may be expressed as UTC +9, and the time in the United States may be expressed as UTC -5.

Referring to FIG. 9, the server device 200 may transmit content A and the disclosure start time of the content A (9:00 AM on October 1, 2024) to the electronic device 100 located in Korea. When the electronic device 100 is located in the United States or the United Kingdom, instead of disclosing the content A at 9:00 AM on October 1, 2024, which is the disclosure start time of the content A, the content A may be disclosed based on the UTC time information of the country where the electronic device 100 is located.

For example, when the electronic device 100 is located in the United States, the server device 200 may convert the disclosure start time of the content A into the UTC information of the United States and transmit the playback schedule information including the converted disclosure start time (7:00 PM on September 30, 2024) information to the electronic device 100.

For example, when the electronic device 100 is located in the United Kingdom, the server device 200 may convert the disclosure start time of the content A into the UTC information of the United Kingdom and transmit the playback schedule information including the converted disclosure start time (00:00:00 on October 01, 2024) information to the electronic device 100.

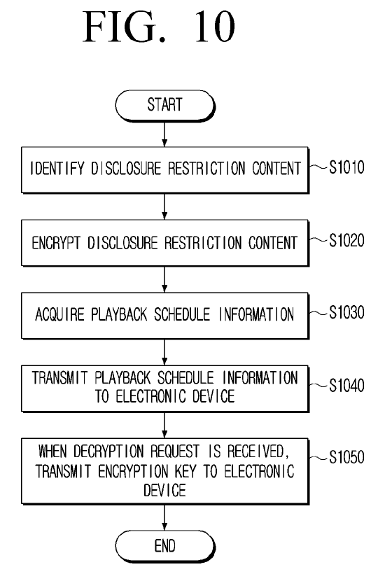

FIG. 10 is a flowchart for describing an overall operation of a server device according to one or more embodiments.

Referring to FIG. 10, in operation S1010, when the plurality of pieces of content, and the disclosure restriction status and the validity period information corresponding to each of the plurality of pieces of content are received, the server device 200 may identify the disclosure restriction content with the disclosure restriction set among the plurality of pieces of content.

In operation S1020, the server device 200 may encrypt the disclosure restriction content using the encryption key.

In operation S1030, the server device 200 may acquire the playback schedule information of the plurality of pieces of content including the encrypted disclosure restriction content.

In operation S1040, the server device 200 may transmit the playback schedule information to the electronic device 100.

In operation S1050, when a request for decryption of the disclosure restriction content is received from the electronic device 100, the server device 200 may transmit the encryption key corresponding to the disclosure restriction content to the electronic device 100.

Since the method for identifying disclosure restriction content and acquiring playback schedule information has been specifically described through the above-described embodiments, the description thereof will be omitted.

The control method described in FIG. 6 may be performed by the electronic device 100 having the configuration of FIG. 2 described above, but is not necessarily limited thereto, and may be performed by the electronic device having various configurations.

The control method described in FIG. 10 may be performed by the server device 200 having the configuration of FIG. 7 described above, but is not necessarily limited thereto, and may be performed by the server device having various configurations.

One or more embodiments described above may be implemented as embodiments alone, or at least an embodiment may be combined with each other in whole or in part and implemented together in one device.

According to the one or more embodiments described above, the electronic device 100 may strengthen security and minimize content leakage by encrypting the plurality of pieces of advertising content and displaying the encrypted advertising content through the display at the preset disclosure start time and disclosure end time.

One or more embodiments described above may be applied to a product as embodiments alone, or at least some of the contents may be combined with other embodiments of the present disclosure and implemented together.

One or more embodiments described above may be implemented by software including instructions stored in a machine-readable storage medium (for example, a computer-readable storage medium). A machine is a device capable of calling a stored instruction from a storage medium and operating according to the called instruction, and may include the electronic device 100 of the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory computer-readable storage medium. Here, the term “non-transitory” means that the storage medium is tangible without including a signal, and does not distinguish whether data are semi-permanently or temporarily stored in the storage medium.

In addition, according to an embodiment of the disclosure, the above-described methods according to the diverse embodiments may be included and provided in a computer program product.

Specifically, there may be provided a non-transitory readable storage medium or a computer program product storing a computer command causing the following operations to be performed: receiving playback schedule information that includes a plurality of pieces of content, and disclosure restriction status and validity period information corresponding to each of the plurality of pieces of content, identifying disclosure restriction content to which encryption is applied among the plurality of pieces of content, transmitting a decryption request for the disclosure restriction content to a server device when a time before a predetermined time is reached based on a playback start time of the disclosure restriction content, decrypting the disclosure restriction content based on the encryption key when an encryption key corresponding to the disclosure restriction content is received from the server device, and displaying the plurality of pieces of content including the decrypted disclosure restriction content based on the validity period information.

The computer program product may be distributed in a form of a storage medium (for example, a compact disc read only memory (CD-ROM)) that may be read by the machine or online through an application store (for example, PlayStore^{TM}). In case of the online distribution, at least a portion of the computer program product may be at least temporarily stored in a storage medium such as a memory of a server of a manufacturer, a server of an application store, or a relay server or be temporarily generated.

Computer instructions for performing the control method of an electronic device, etc., according to one or more embodiments of the disclosure described above or programs may be stored in the non-transitory computer-readable medium. The computer instructions stored in the non-transitory computer-readable medium allow a specific machine to perform the processing operations in the machine according to the diverse embodiments described above when they are executed by a processor of the specific machine. The non-transitory computer-readable medium is not a medium that stores data for a while, such as a register, a cache, a memory, or the like, but means a medium that semi-permanently stores data and is readable by the apparatus. A specific example of the non-transitory computer-readable medium may include a CD, a DVD, a hard disk, a Blu-ray disk, a universal serial bus (USB), a memory card, a ROM, or the like.

Although specific embodiments of the disclosure are shown and described hereinabove, the disclosure is not limited to the above-mentioned specific embodiments, and may be variously modified by those skilled in the art to which the disclosure pertains without departing from the scope and spirit of the disclosure as disclosed in the accompanying claims. These modifications fall within the scope and spirit of the disclosure.

What is claimed is:

1. An electronic device comprising:
communication circuitry;
a display;
a memory configured to store instructions; and
one or more processors configured to comprise a processing circuitry,
wherein, when the instructions are individually or collectively executed, the one or more processors cause the electronic device to:
receive, through the communication circuitry, playback schedule information that comprises a plurality of pieces of content, a disclosure restriction status, and validity period information, wherein the disclosure restriction status and the validity period information correspond to each of the plurality of pieces of content,
identify, among the plurality of pieces of content, disclosure restriction content to which an encryption is applied,
when a predetermined time, which is prior to a disclosure start time of the disclosure restriction content, is reached, transmit a decryption request for the disclosure restriction content to the server device through the communication circuitry,
when an encryption key corresponding to the disclosure restriction content is received from the server device, decrypt the disclosure restriction content using the encryption key, and
display, on the display, the plurality of pieces of content comprising the decrypted disclosure restriction content based on the validity period information.

2. The electronic device of claim 1, wherein, when individually or collectively executed by the one or more processors, the instructions further cause the electronic device to:
store, in the memory, the playback schedule information that comprises the plurality of pieces of content, the disclosure restriction status, and the validity period information that are received through the communication circuitry, and
delete the disclosure restriction content from the memory when a deletion request for the disclosure restriction content is received from the server device after a validity period of the disclosure restriction content expires.

3. The electronic device of claim 1, wherein the validity period information comprises at least one of the disclosure start time and a disclosure end time corresponding to each of the plurality of pieces of content, and
wherein the disclosure restriction status comprises information on whether the content is played before a validity period corresponding to the content is reached.

4. The electronic device of claim 1, wherein the predetermined time is determined based on at least one of a capacity of the disclosure restriction content or a network environment.

5. The electronic device of claim 1, wherein the electronic device is a digital signage device, and
wherein the plurality of pieces of content comprise advertising content.

6. A server device comprising:
communication circuitry;
a memory configured to store instructions; and
one or more processors configured to comprise a processing circuitry,
wherein, when the instructions are individually or collectively executed, the one or more processors cause the server device to:
when a plurality of pieces of content, disclosure restriction status, and validity period information are received, identify, among the plurality of pieces of content, disclosure restriction content with a disclosure restriction set, wherein the disclosure restriction status and the validity period information correspond to each of the plurality of pieces of content,
encrypt the disclosure restriction content using an encryption key,
acquire playback schedule information of the plurality of pieces of content comprising the encrypted disclosure restriction content,
transmit the playback schedule information to the electronic device through the communication circuitry, and
when a request for decryption of the disclosure restriction content is received from the electronic device, transmit the encryption key corresponding to the disclosure restriction content to the electronic device through the communication circuitry.

7. The server device of claim 6, wherein the validity period information comprises at least one of a disclosure start time or a disclosure end time corresponding to each of the plurality of pieces of content, and
wherein the disclosure restriction status comprises information on whether the content is played before a validity period corresponding to the content is reached.

8. The server device of claim 6, wherein, when individually or collectively executed by the one or more processors, the instructions further cause the server device to:
identify, among the plurality of pieces of content, the disclosure restriction content based on disclosure restriction information for activating disclosure restriction, and
store the identified encryption key in the memory.

9. The server device of claim 6, wherein the electronic device is a digital signage device,
wherein when individually or collectively executed by the one or more processors, the instructions further cause the server device to receive, from a plurality of advertising business servers, a plurality of advertising contents, the disclosure restriction status, and the validity period information, and
wherein the disclosure restriction status and the validity period information correspond to each of the plurality of advertising contents.

10. The server device of claim 6, wherein, when executed individually or collectively by the one or more processors, the instructions further cause the server device to convert the validity period information corresponding to the plurality of pieces of content into coordinated universal time (UTC) information of a country where the electronic device is located, and
transmit, to the electronic device, the playback schedule information comprising the converted validity period information.

11. A method of an electronic device comprising:
receiving playback schedule information that comprises a plurality of pieces of content, a disclosure restriction status, and validity period information, wherein the disclosure restriction status and the validity period information correspond to each of the plurality of pieces of content;
identifying disclosure restriction content to which encryption is applied among the plurality of pieces of content;
transmitting a decryption request for the disclosure restriction content to the server device when a time before a predetermined time is reached based on a playback start time of the disclosure restriction content;
when an encryption key corresponding to the disclosure restriction content is received from the server device, decrypting the disclosure restriction content using the encryption key; and
displaying, on the display, the plurality of pieces of content comprising the decrypted disclosure restriction content based on the validity period information.

12. The method of claim 11, further comprising:
storing, in the electronic device, the playback schedule information that comprises the plurality of pieces of content, the disclosure restriction status, and the validity period information, wherein the disclosure restriction status and the validity period information correspond to each of the plurality of pieces of content received from the server device; and
deleting the disclosure restriction content from the electronic device when a deletion request for the disclosure restriction content is received from the server device after a validity period of the disclosure restriction content expires.

13. The method of claim 11, wherein the validity period information comprises at least one of a disclosure start time and a disclosure end time that correspond to each of the plurality of pieces of content, and
wherein the disclosure restriction status comprises information on whether the content is played before a validity period corresponding to the content is reached.

14. The method of claim 11, wherein the predetermined time is determined based on at least one of a capacity of the disclosure restriction content or a network environment.

15. The method of claim 11,
wherein the electronic device is a digital signage device, and
wherein the plurality of pieces of content comprise advertising content.

16. A non-transitory computer-readable storage medium storing a computer command that, when executed by a processor of an electronic device, causes the electronic device to perform an operation, wherein the operation comprises:
receiving playback schedule information that comprises a plurality of pieces of content, a disclosure restriction status, and validity period information, wherein the disclosure restriction status and the validity period information correspond to each of the plurality of pieces of content;
identifying disclosure restriction content to which encryption is applied among the plurality of pieces of content;
transmitting, to the server device, a decryption request for the disclosure restriction content when a time before a predetermined time is reached based on a playback start time of the disclosure restriction content;
when an encryption key corresponding to the disclosure restriction content is received from the server device, decrypting the disclosure restriction content using the encryption key; and
displaying, on the display, the plurality of pieces of content comprising the decrypted disclosure restriction content based on the validity period information.

17. The non-transitory computer readable medium of claim 16,
storing, in the electronic device, the playback schedule information that comprises the plurality of pieces of content, the disclosure restriction status, and the validity period information, wherein the disclosure restriction status and the validity period information correspond to each of the plurality of pieces of content received from the server device; and
deleting the disclosure restriction content from the electronic device when a deletion request for the disclosure restriction content is received from the server device after a validity period of the disclosure restriction content expires.

18. The non-transitory computer readable medium of claim 16,
wherein the validity period information comprises at least one of a disclosure start time and a disclosure end time that correspond to each of the plurality of pieces of content, and
wherein the disclosure restriction status comprises information on whether the content is played before a validity period corresponding to the content is reached.

19. The non-transitory computer readable medium of claim 16,
wherein the predetermined time is determined based on at least one of a capacity of the disclosure restriction content or a network environment.

20. The non-transitory computer readable medium of claim 16,
wherein the electronic device is a digital signage device, and
wherein the plurality of pieces of content comprise advertising content.
